(19) United States
(12) Patent Application Publication
(10) Pub. No.: US 2016/0129564 A1
(43) Pub. Date: May 12, 2016

(54) Reversible ratchet wrench

(71) Applicants: Ching Chen, Taichung (TW); Cheng-Han Lee, Taichung (TW)

(72) Inventors: Ching Chen, Taichung (TW); Cheng-Han Lee, Taichung (TW)

(21) Appl. No.: 14/995,203

(22) Filed: Jan. 14, 2016

(51) Int. Cl. B25B 13/46

(52) U.S. Cl. CPC B25B 13/463

(57) ABSTRACT

A reversible ratchet wrench includes a head including a through opening, a cavity on an inner surface of the through opening, and an open well on an inner surface of the cavity; a drive gear including external drive teeth and rotatably supported in the through opening; first and second reversing pawls each including pawl teeth and a detent notch wherein the detent notches communicates with each other, the pawl teeth of the second reversing pawl engage the drive teeth, and the first and second reversing pawls are in the cavity; a reversing lever including an exposed thumb tab, a recess on an inner surface, and a slit communicating with the recess; and a biasing member including first and second ends urging against the detent notches. The biasing member is anchored in the slit and urges against the well.

### BACKGROUND OF THE INVENTION

1. Field of the Invention

The invention relates to ratchet wrenches and more particularly to a reversible ratchet wrench having improved characteristics.

2. Description of Related Art

There is a type of reversible ratchet wrench comprises a handle; a head formed with the handle and having a cavity; a rotatable member rotatably disposed in the head and having ratchet teeth around a periphery thereof, the cavity being open to a periphery of the rotatable member and having opposite side walls diverging in the direction of the periphery of the rotatable member, a pawl within the cavity having along one edge ratchet teeth configured to engage the ratchet teeth on the rotatable member and having a pair of side walls diverging in a direction toward the edge, the pawl being configured to shift in the cavity circumferentially of the rotatable member in opposite directions as limited by engagement of the side walls of the pawl and the side walls of the cavity and being configured to further shift in the cavity in a direction radially of the rotatable member, and a biasing member configured to bias the pawl so that it tends to move in a direction toward the rotatable member.

While the device enjoys its success in the market, continuing improvements in the exploitation of reversible ratchet wrench are constantly sought.

### SUMMARY OF THE INVENTION

It is therefore one object of the invention to provide a reversible ratchet wrench comprising a handle; a head formed with the handle and including a through opening, an annular trough disposed on an inner surface of the through opening adjacent to a top thereof, a cavity disposed on an inner surface of the through opening, and an open well disposed on an inner surface of the cavity; a drive gear including an annular groove adjacent to a top thereof, external drive teeth disposed on an outer surface, and a split ring disposed in both the annular groove and the annular trough to hold the drive gear in place so that the drive gear is rotatably supported in the through opening; a first reversing pawl including pawl teeth disposed on a first surface and a detent notch disposed on an opposite second surface; a second reversing pawl engaged a bottom of the first reversing pawl and including pawl teeth disposed on a first surface and a detent notch disposed on an opposite second surface wherein the detent notch of the first reversing pawl communicates with the detent notch of the second reversing pawl, the pawl teeth of the second reversing pawl engage the drive teeth, and the first and second reversing pawls are disposed in the cavity; a reversing lever including a body disposed in the well, an exposed thumb tab, a recess disposed on a surface of the body, and a slit disposed in the body and communicating with the recess; and a biasing member including a first end urging against the detent notch of the first reversing pawl and a second end urging against the detent notch of the second reversing pawl wherein the biasing member is anchored in the slit and urging against an inner surface of the well; wherein a clockwise rotation of the thumb tab counterclockwise moves both the first and second reversing pawls and the drive gear is capable of counterclockwise moving only; and wherein a counterclockwise rotation of the thumb tab clockwise moves both the first and second reversing pawls and the drive gear is capable of clockwise moving only.

The above and other objects, features and advantages of the invention will become apparent from the following detailed description taken with the accompanying drawings.

### BRIEF DESCRIPTION OF THE DRAWINGS

FIG. 1 is a perspective view of a reversible ratchet wrench according to the invention;

FIG. 2 is a perspective view of the wrench head shown in phantom;

FIG. 3 is an exploded view of the wrench head;

FIG. 4 is another exploded view of the wrench head, seen from another angle;

FIG. 5 is a longitudinal sectional view of the wrench head;

FIG. 6 is a cross-sectional view of the wrench head showing a clockwise rotation of the reversing lever;

FIG. 7 is a view similar to FIG. 6 showing a counterclockwise rotation of the reversing lever; and

FIG. 8 is an exploded view of the drive gear, the first reversing pawl, the second reversing pawl, the biasing member, and the reversing lever.

### DETAILED DESCRIPTION OF THE INVENTION

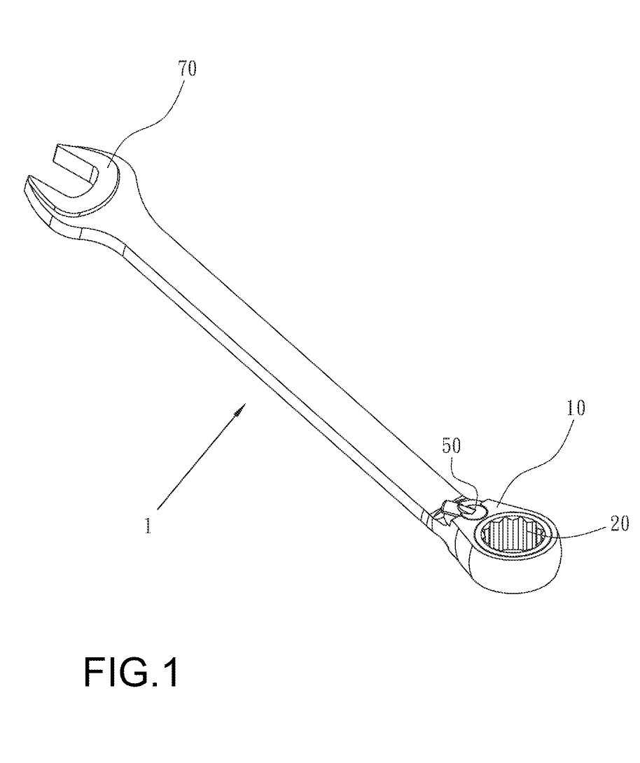

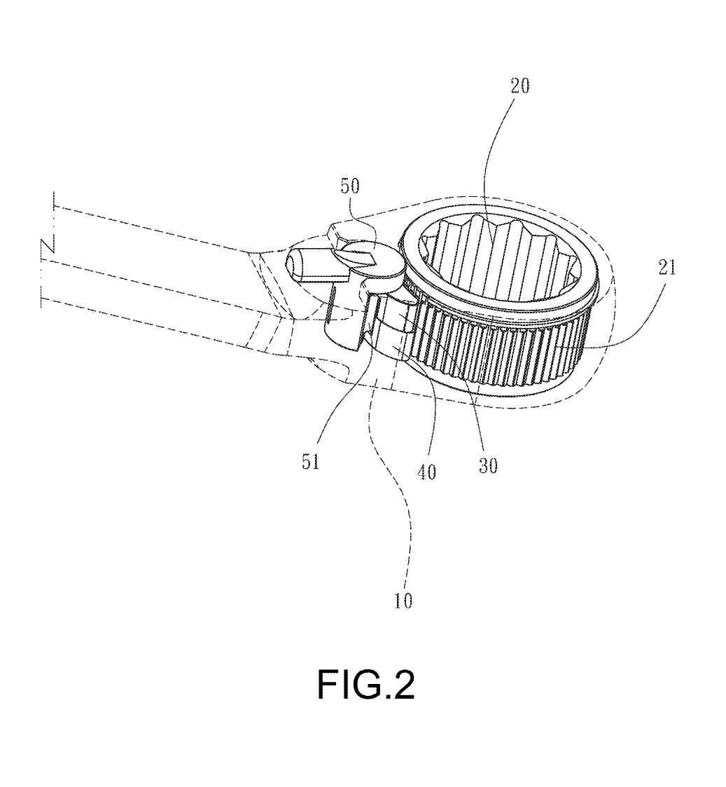

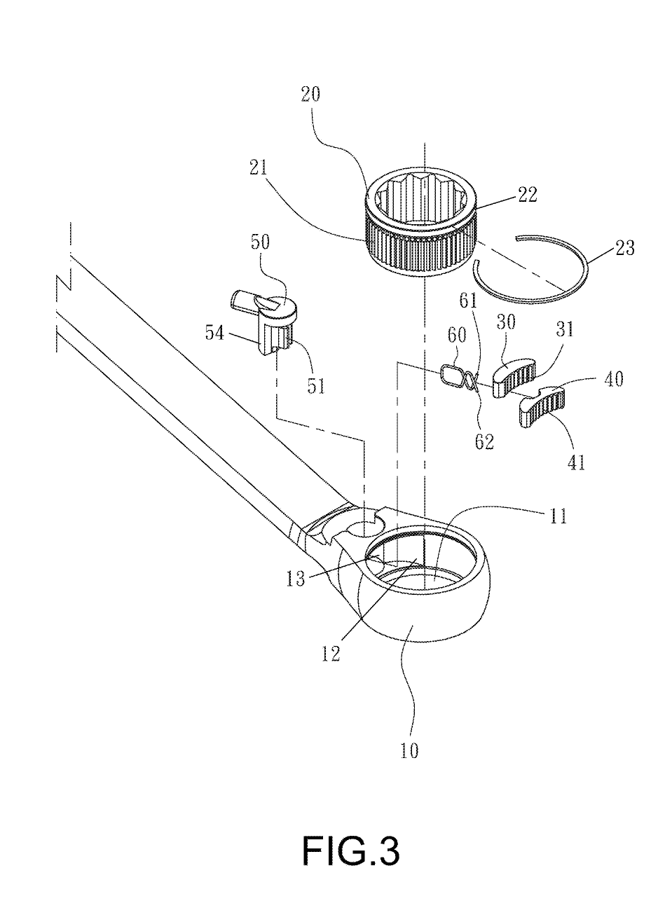

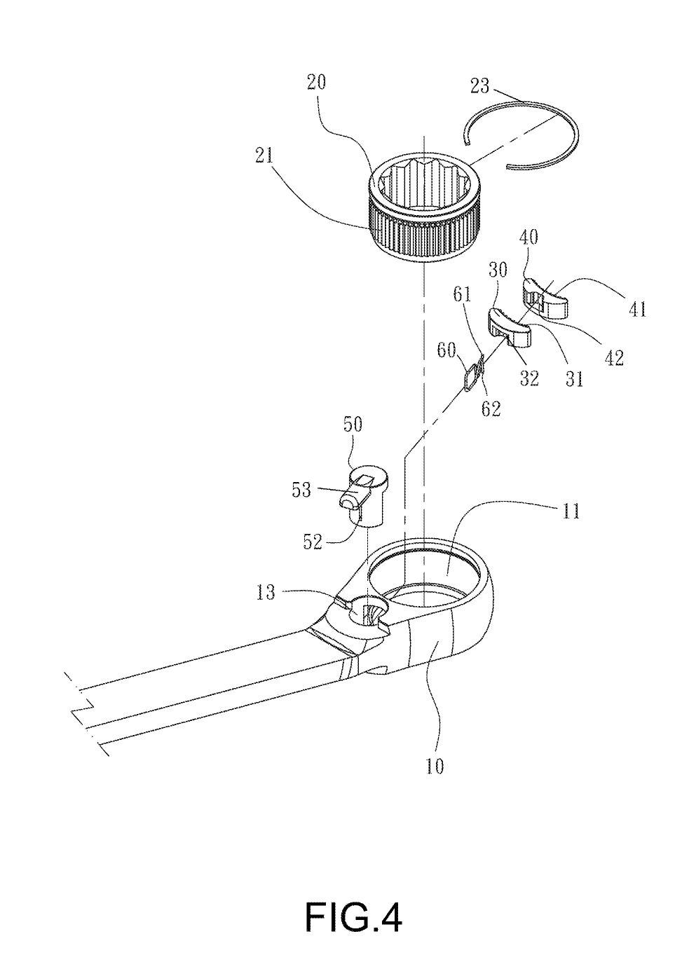

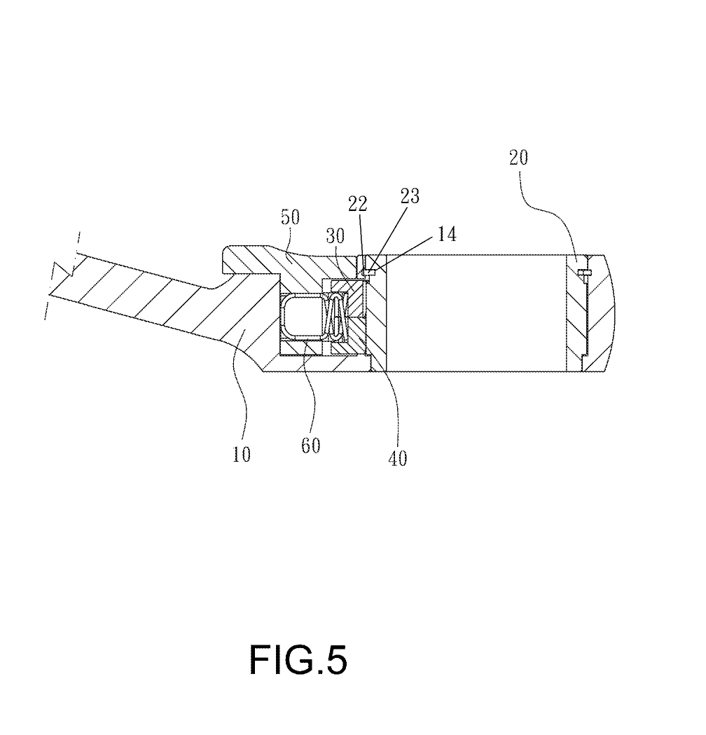

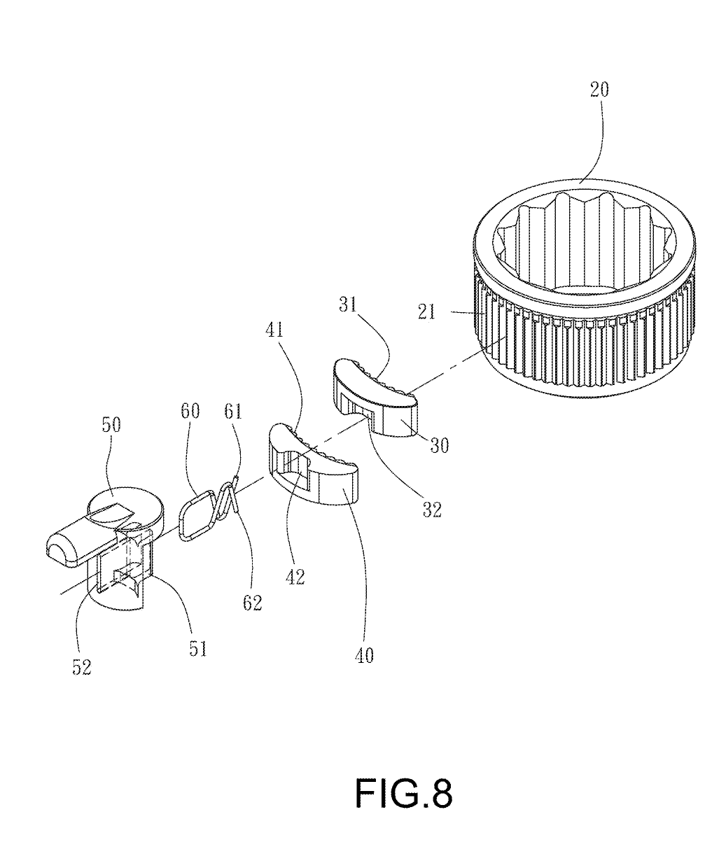

Referring to FIGS. 1 to 8, a reversible ratchet wrench in accordance with the invention comprises the following components as discussed in detail below.

A handle 1 has one end 70 formed with a U-shaped opening and the other end formed as a head 10. The head 10 includes a through opening 11, a cavity 12 on an inner surface of the through opening 11, a well 13 on an inner surface of the cavity 12, the well 13 open to a top surface of the head 10, and an annular trough 14 on an inner surface of the through opening 11 adjacent to a top thereof.

A drive gear 20 includes an annular groove 22 adjacent to a top thereof, external drive teeth 21, and a split ring 23 disposed in both the groove 20 and the trough 14 to hold the drive gear 20 in place so that the drive gear 20 may be rotatably supported in the through opening 11.

A first reversing pawl 30 includes pawl teeth 31 on a first surface and a detent notch 32 on an opposite second surface. A second reversing pawl 40 engaged a bottom of the first reversing pawl 30 and includes pawl teeth 41 on a first surface and a detent notch 42 on an opposite second surface, the detent notch 42 communicating with the detent notch 32. Only the pawl teeth 41 engage the drive teeth 21. The first and second reversing pawls 30, 40 are disposed in the cavity 12. The first and second reversing pawls 30, 40 are substantially equal in size.

A reversing lever 50 includes a body 54 disposed in the well 13, an exposed thumb tab 53, a recess 51 on a surface of the body 54, and a slit 52 in the body 54 and communicating with the recess 51.

A biasing member 60 includes a first end 61 urging against the detent notch 32 and a second end 62 urging against the detent notch 42. The biasing member 60 is anchored in the slit 52 and urging against an inner surface of the well 13.

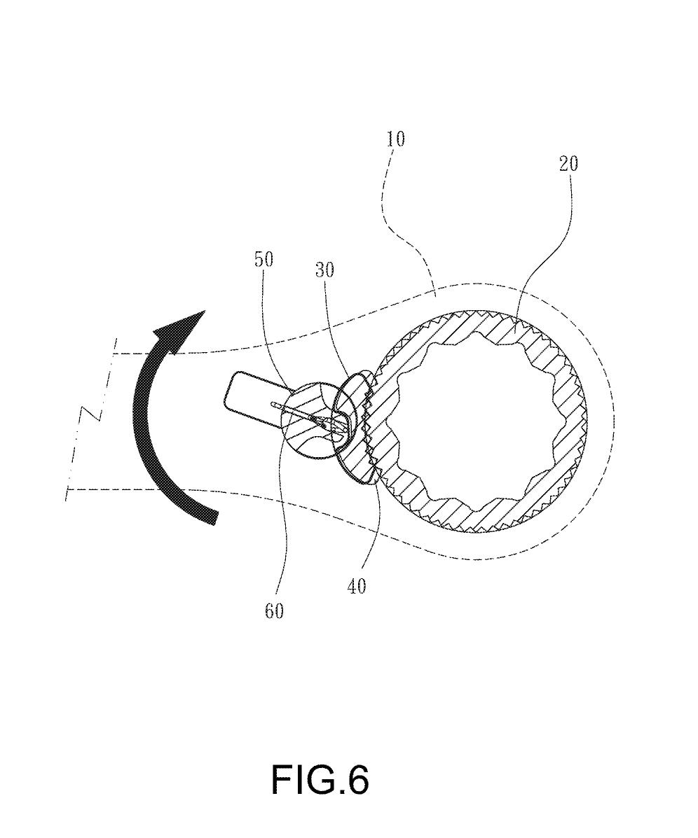

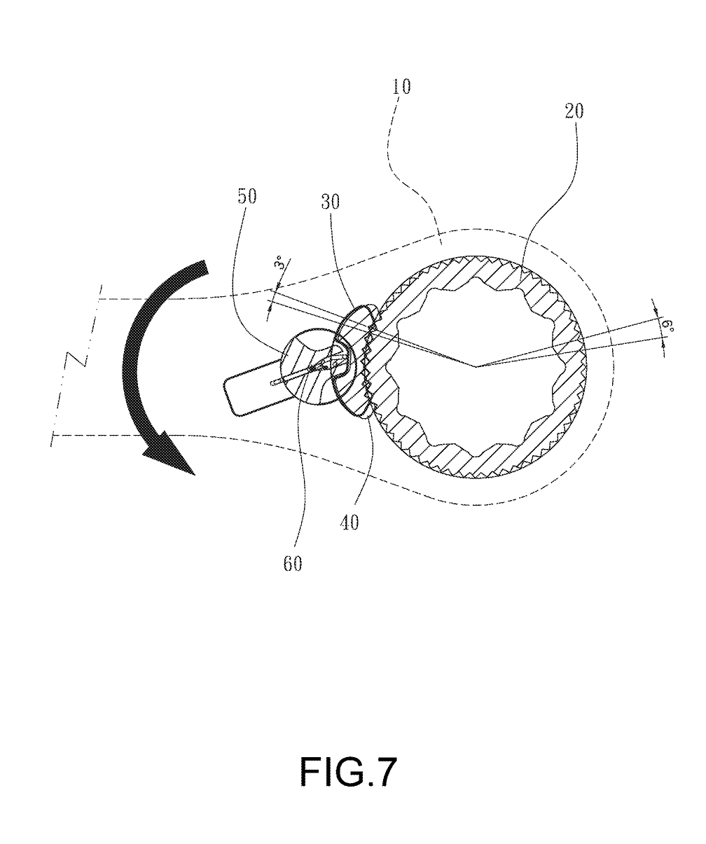

A clockwise manual rotation of the thumb tab 53 pivotably moves both the first and second reversing pawls 30, 40 counterclockwise and the drive gear 20 is capable of pivotably, counterclockwise moving only (see FIG. 6). A counterclockwise manual rotation of the thumb tab 53 pivotably moves both the first and second reversing pawls 30, 40 clockwise and the drive gear 20 is capable of pivotably, clockwise moving only (see FIG. 7).

As shown in FIG. 7, a pivotal movement of an angle of 3-degree of the first reversing pawl 30 or the second reversing pawl 40 causes a pivotal movement of an angle of 6-degree of the drive gear 20.

While the invention has been described in terms of preferred embodiments, those skilled in the art will recognize that the invention can be practiced with modifications within the spirit and scope of the appended claims.

What is claimed is:

1. A reversible ratchet wrench comprising:
a handle;
a head formed with the handle and including a through opening, an annular trough disposed on an inner surface of the through opening adjacent to a top thereof, a cavity disposed on an inner surface of the through opening, and an open well disposed on an inner surface of the cavity;
a drive gear including an annular groove adjacent to a top thereof, external drive teeth disposed on an outer surface, and a split ring disposed in both the annular groove and the annular trough to hold the drive gear in place so that the drive gear is rotatably supported in the through opening;
a first reversing pawl including pawl teeth disposed on a first surface and a detent notch disposed on an opposite second surface;
a second reversing pawl engaged a bottom of the first reversing pawl and including pawl teeth disposed on a first surface and a detent notch disposed on an opposite second surface wherein the detent notch of the first reversing pawl communicates with the detent notch of the second reversing pawl, the pawl teeth of the second reversing pawl engage the drive teeth, and the first and second reversing pawls are disposed in the cavity;
a reversing lever including a body disposed in the well, an exposed thumb tab, a recess disposed on a surface of the body, and a slit disposed in the body and communicating with the recess; and
a biasing member including a first end urging against the detent notch of the first reversing pawl and a second end urging against the detent notch of the second reversing pawl wherein the biasing member is anchored in the slit and urging against an inner surface of the well;
wherein a clockwise rotation of the thumb tab counterclockwise moves both the first and second reversing pawls and the drive gear is capable of counterclockwise moving only; and
wherein a counterclockwise rotation of the thumb tab clockwise moves both the first and second reversing pawls and the drive gear is capable of clockwise moving only.
